(19) United States
(12) Patent Application Publication
(10) Pub. No.: US 2015/0353418 A1
(43) Pub. Date: Dec. 10, 2015

(54) SCRATCH-RESISTANT CHEMICALLY TEMPERED GLASS SUBSTRATE AND USE THEREOF

(71) Applicant: SCHOTT AG, Mainz (DE)

(72) Inventors: Thorsten Damm, Nieder-Olm (DE); Christian Henn, Frei-Laubersheim (DE)

(21) Appl. No.: 14/725,983

(22) Filed: May 29, 2015

(30) Foreign Application Priority Data
Jun. 6, 2014 (DE) 102014108057.2

(51) Int. Cl. C03C 17/34; G02B 1/115; C03C 21/00

(52) U.S. Cl. CPC C03C 17/3417; C03C 21/00; C03C 17/3435; G02B 1/115; C03C 2217/213; C03C 2217/214; C03C 2217/281; C03C 2217/734; C03C 2218/155; C03C 2218/156

(57) ABSTRACT

An object of the disclosure is to provide a layer system for a chemically tempered glass substrate, which adheres particularly well to the glass substrate and provides an anti-reflective effect and particularly high scratch resistance. Accordingly, the invention provides a scratch-resistant chemically tempered glass element, comprising a chemically tempered glass substrate having a potassium-rich surface, and a layer system which comprises a plurality of successive layers including an oxygen-rich layer adjacent the potassium-rich surface of the glass substrate. The oxygen-rich layer comprises predominantly silicon oxide and/or aluminum oxide, and is an adhesion promoting layer for a nitridic hard material layer which is the lowermost part of a multi-layered, in particular four-layered, anti-reflective coating. The anti-reflective coating is composed of layers of different refractive indices, alternating higher refractive indices and lower refractive indices.

### CROSS-REFERENCE TO RELATED APPLICATIONS

The present disclosure claims the benefit of German Patent Application No. 102014108057.2, filed on June 6, 2014, and which is herein incorporated by reference in its entirety.

### BACKGROUND OF THE DISCLOSURE

1. Field of the Disclosure

The invention generally relates to chemically tempered glasses having a special coating system.

2. Description of Related Art

Chemically tempered glasses for mobile electronic devices, such as smart phones, tablet computers, navigation systems, etc., are well known. Such glass usually is an aluminosilicate glass having a refractive index of greater than 1.5 at a wavelength of 550 nm. In the process of chemical tempering in which sodium ions of the glass are exchanged for potassium ions from a salt bath, the potassium accumulates in a zone of several micrometers near the surface. The potassium content is in a range of up to a few percent by mass. By the chemical tempering an increase in flexural strength and scratch resistance is achieved. Nonetheless, after a relatively short period of use of a typical product, damage to the surface in form of scratches is often apparent. Although the chemical tempering prevents the glass from easily breaking when subjected to bending stress, since the compressive pre-stress prevents or delays a crack caused by a scratch, for example, from spreading, however, scratches usually cannot be avoided.

Furthermore, anti-reflective coatings have been known for avoiding reflections on glass surfaces, which depending on the implementation consist of several layers which are applied on one side or both sides of the glass substrate. Depending on the application of the product, a mechanically stable, i.e. damage-resistant or scratch-resistant design of the antireflection system is desirable or necessary. The overall objective of an optical anti-reflective coating is primarily to evenly suppress reflection of the visible portion of the electromagnetic spectrum, so that there is no color conspicuousness resulting from an uneven residual reflection, if possible. An example of such a color-neutral scratch-resistant anti-reflective coating is given in US 2012/0212826. However, it is not possible for such an anti-reflection system composed of four layers to be readily applied to a chemically tempered glass such as those employed in the field of mobile electronic equipment, for example. This is because of the chemically altered surface of the glass caused by chemical tempering, which reduces the bonding of a nitridic hard material of the anti-reflective coating thereto, so that delamination effects may arise. Moreover, in many cases the anti-reflection systems mentioned above still provide insufficient mechanical resistance for being employed in applications of mobile electronic devices, such as smartphones.

### SUMMARY OF THE DISCLOSURE

The invention is therefore based on the object to provide a coating system for a chemically tempered glass substrate, which adheres particularly well to the glass substrate, has an anti-reflective effect and a particularly high scratch resistance. Preferably, layer-induced deformation or warpage of the glass should be kept as low as possible. For a further preferred embodiment of the invention, a further object is to provide a coating system for a chemically tempered glass substrate, which reduces the conspicuousness of fingerprints or is at least easy to clean.

These objects are achieved by the subject matter of the independent claims. Advantageous embodiments and modifications of the invention are disclosed in the respective dependent claims.

Accordingly, the invention provides a scratch-resistant chemically tempered glass element comprising a chemically tempered glass substrate having a potassium-rich surface, and a layer system comprising a plurality of successive layers including an oxygen-rich layer adjacent the potassium-rich surface of the glass substrate, which oxygen-rich layer comprises predominantly silicon oxide and/or aluminum oxide and is an adhesion promoting layer for a nitridic hard material layer which is the lowermost part of a multi-layered, in particular four-layered, anti-reflective coating. The anti-reflective coating is composed of layers of different refractive indices, alternating higher refractive indices and lower refractive indices.

The good bonding of the lowermost and lower nitridic hard material layer to the chemically tempered glass substrate having the potassium-rich surface is achieved by using an adhesion promoter which ideally has a refractive index similar to that of the glass substrate, preferably similar in the visible spectral range or advantageously at a wavelength of about 550 nm, in particular with a deviation of less than 10%. Preferably, the layer thickness of the adhesion promoting layer is designed so as to be visually unobtrusive. That means, the average reflectance in the range of wavelengths from 380 nm to 780 nm preferably varies by less than 0.5%, more preferably by less than 0.2%.

It has been found that a thin adhesion promoting layer which mainly consists of silicon oxide (SiO₂), but which may also include proportions of aluminum oxide or may consist predominately of aluminum oxide is particularly suitable as such an adhesion promoter. Preferably, the oxygen-rich layer has a layer thickness from 1 nm to 100 nm, more preferably from 1 nm to 50 nm, and most preferably from 1 nm to 20 nm.

Apparently, in contrast to the nitridic layer, this thin oxygen-rich layer creates a strong chemical bonding to the potassium-rich surface of the chemically tempered glass substrate, so that delamination does not occur or is prevented.

This thin adhesion promoting layer preferably has a smaller thickness than any other individual layer of the anti-reflective coating.

In a preferred embodiment of the anti-reflective coating, the upper nitridic hard material layer has the largest layer thickness of the anti-reflective coating and of the entire layer system, with a thinner layer thickness of the upper nitridic hard material layer in a range from 100 nm to 200 nm, preferably from 130 nm to 170 nm, which provides for a design of the anti-reflective coating that exhibits neutral color reflectivity, or alternatively with a medium layer thickness of the upper nitridic hard material layer from 200 nm to 300 nm, preferably from 230 nm to 290 nm, which provides for a design of the anti-reflective coating that exhibits nearly neutral color reflectivity and further exhibits improved scratch resistance as compared to the first-mentioned coating. In a further alternative preferred embodiment of the anti-reflective coating, the upper nitridic hard material layer has a thicker layer thickness in a range from 300 nm to 1000 nm, preferably in a range from 350 nm to 600 nm, most preferably from 400 nm to 500 nm, so that an anti-reflective coating with sufficiently good anti-reflective effect and with enhanced scratch-resistance is obtained.

With the specific configuration or structure of the anti-reflective coatings with a medium thick layer thickness of the upper nitridic hard material layer or with a significantly thicker hard material layer than is typically used in a color-neutral antireflection system, increased scratch resistance is achieved.

The upper nitridic hard material layer preferably accounts for a fraction of the total layer thickness of the layer system of at least 0.4, preferably at least 0.6, more preferably at least 0.7.

Preferably, the layer system additionally comprises an organofluorine layer adjacent to the uppermost layer of the anti-reflective coating. In particular, this layer may be a monolayer of organofluorine molecules, preferably with a layer thickness from 1 nm to 20 nm, more preferably with a layer thickness from 1 nm to 10 nm. For example, the organofluorine layer may be a hard, oleophobic coating having an anti-reflective effect, from any manufacturer. In addition, all coating processes known from prior art may be used for applying such organofluorine layers on the aforementioned layer systems, such as spin coating, spray coating, and evaporation coating, in a separate coating apparatus or within a single sputtering or vapor deposition apparatus.

Surprisingly, it has been found that a layer system in which an additional organofluorine layer is added onto an anti-reflective coating that includes a thick upper nitridic hard material layer which in particular has the greatest thickness of the anti-reflective coating, is not only effective to reduce the conspicuousness of fingerprints and to be easy to clean, but that the so coated chemically tempered glass substrate and hence the glass element of the invention in particular helps to prevent scratches.

This is attributed to the fact that the additional organofluorine layer probably reduces the friction coefficient of the surface so that damage to the surface will be smaller, since an object impacting on the surface can easily glace off.

Preferably, the nitridic hard material layers comprise silicon nitride including a proportion of aluminum, with a ratio of the molar amounts of aluminum to silicon of preferably greater than 0.05, more preferably greater than 0.08.

It has been found that coating systems based on silicon nitride exhibit significantly reduced layer-induced warpage or deformation with increasing layer thickness as compared to systems based on aluminum nitride. Consequently, here, a silicon nitride-based layer system is preferred over an aluminum nitride-based system, in particular for glasses for which lowest possible warpage is important.

A glass substrate presently used has been chemically tempered by an exchange of sodium ions or lithium ions for potassium ions at the surface thereof, wherein preferably the compressive stress in the surface of the glass substrate is at least 700 MPa and the exchange depth of the alkali ions is at least 25 μm. More preferably, the compressive stress in the surface of the glass substrate is at least 750 MPa and the exchange depth of the alkali ions is at least 30 μm. Most preferably, the compressive stress in the surface of the glass substrate is more than 800 MPa and the exchange depth of the alkali ions is at least 35 um.

In a preferred embodiment, the composition of the chemically tempered glass in the interior of the glass substrate comprises the following components, in mole percent:
SiO₂ 56-70
Al₂O₃ 10.5-16
B₂O₃ 0-3
P₂O₅ 0-3
Na₂O 10-15
K₂O 0-2
MgO 0-5
ZnO 0-3
TiO₂ 0-2.1
SnO₂ 0-1
F 0-5, and
0-2, preferably 0-1 of other components.

The employed glass substrate preferably has a thickness from 0.25 mm to 2.0 mm, depending on the application.

For producing the scratch-resistant chemically tempered glass element of the invention, the layers of the layer system may be deposited by sputtering, especially by reactive sputtering.

The scratch-resistant chemically tempered glass element of the invention may be used as a cover glass for optical displays of electronic devices with or without touch functionality, in particular mobile devices such as mobile phones, smart phones, tablet PCs or PCs with touch display, monitors, television sets, navigation devices, public displays and terminals, and/or industrial displays.

### DESCRIPTION OF THE DRAWINGS

The invention will now be explained in more detail by way of exemplary embodiments and with reference to the accompanying drawings. The same reference numerals in the drawings designate identical or equivalent elements. In the drawings:

FIG. 1 is a schematic diagram of an exemplary embodiment of a scratch-resistant chemically tempered glass element with a layer system comprising an adhesion promoting layer, a four-layered anti-reflective coating, and an organofluorine layer;

FIG. 2 illustrates layer-induced deformation (warpage) of a glass of 0.7 mm thickness over 150 mm (6 inches), in micrometers (μm), in chemically tempered glass elements with aluminum nitride-based layer systems and with silicon nitride-based layer systems, as a function of layer thickness in nanometers (nm);

FIG. 3 shows bar charts of layer thickness, in nanometers (nm), of three chemically tempered glass substrates having coatings of different thicknesses, including a layer system that comprises an adhesion promoting layer and a four-layered anti-reflective coating that includes an upper nitridic hard material layer of different thicknesses;

FIG. 4 shows reflectances, in percent, of a non-coated chemically tempered glass substrate and of three chemically tempered glass substrates having coatings of different thicknesses according to FIG. 3, as a function of wavelength, in nanometers (nm); and

FIG. 5 shows bar charts of the increase in the haze value after a sandpaper test, for a non-coated chemically tempered glass substrate and for four chemically tempered glass substrates coated with different coatings.

### DETAILED DESCRIPTION OF THE DISCLOSURE

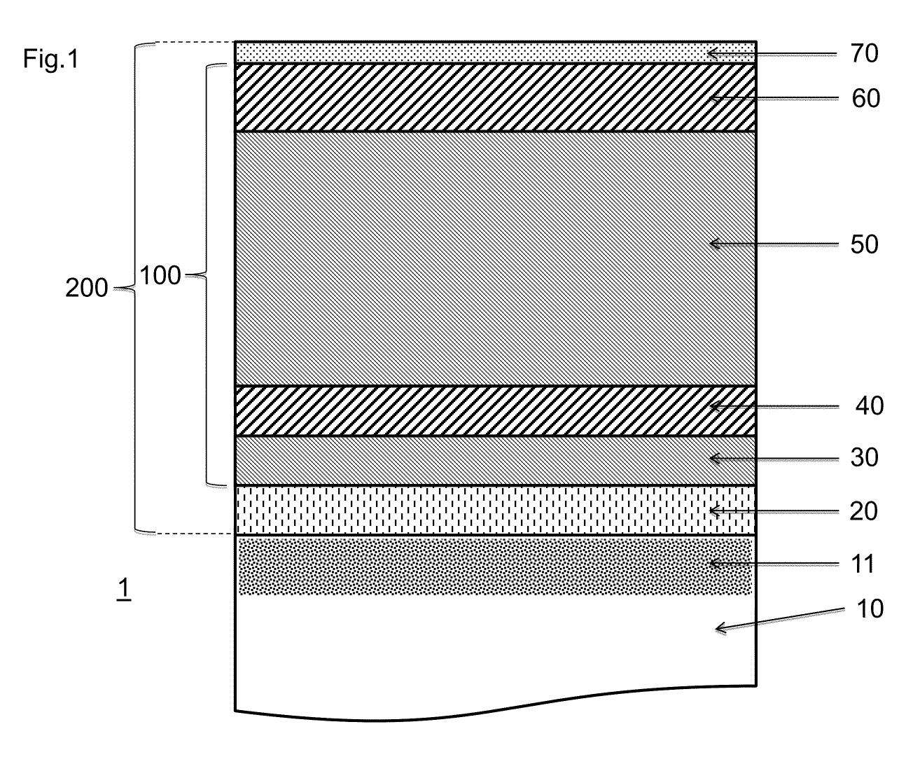

FIG. 1 shows an exemplary glass element 1 in form of a chemically tempered glass substrate 10 having a potassium-rich surface 11 and provided thereon a coating comprising a system 200 of stacked layers. Layer system 200 is based on an adhesion promoting layer 20, a multi-layered, preferably four-layered anti-reflective coating 100, and an optional organofluorine layer 70.

For the glass substrate 10, a fluorine-containing glass with the composition as specified above with an SiO₂ content in the range from 56 to 70 mole percent may be used, for example.

Typically, the glass substrate 10, 11 is provided in form of a sheet or panel, and the adhesion promoting layer 20 is a thin layer rich in oxygen, which mainly comprises silicon oxide, but which may also include proportions of aluminum oxide or may consist predominately of aluminum oxide. This oxygen-rich lowermost layer 20 adheres particularly well to the potassium-rich surface 11 of the glass substrate 10 and provides a adhesion promoter for the lowermost layer of the anti-reflective coating 100, namely a nitridic hard material layer 30.

In order to achieve a good anti-scratch effect on the one hand and a good anti-reflective effect on the other, it is advantageous if the anti-reflective coating comprises at least two layers having a higher refractive index and at least two layers having a lower refractive index.

Therefore, in anti-reflective coating 100 layers having a higher refractive index and layers having a lower refractive index are arranged alternately. Hard material layers 30, 50 which have a higher refractive index include a nitride, and layers 40, 60 which have a lower refractive index preferably include a silicon oxide with a proportion of aluminum, so that the ration of the molar amounts of aluminum to silicon is preferably greater than 0.05, more preferably greater than 0.08, but so that the molar amount of silicon outweighs the molar amount of aluminum. Preferably, the ratio of the molar amounts of aluminum to silicon is from about 0.075 to 0.125, more preferably about 0.1. Therefore, layers 40, 60 which predominantly contain silicon oxide are low-index layers. By contrast, layers 30, 50 are layers having a higher refractive index and preferably comprise silicon nitride, likewise with a proportion of aluminum. Preferably, the ratio of molar amounts of aluminum to silicon is substantially the same in all layers.

In order to achieve the highest possible mechanical resistance, the mechanically more stable component, i.e. silicon nitride or aluminum-doped silicon nitride is used as the lowermost layer 30 of the anti-reflective coating 100 in form of a thin layer since it determines the growth of the rest of the system of alternating layer. It is followed by a thin aluminum-doped SiO₂ layer 40 which in turn is followed by a particularly thick aluminum-doped Si₃N₄ hard material layer 50 which achieves the resistance to the outside. A subsequent thinner aluminum-doped SiO₂ layer 60 is deposited such that the desired anti-reflective effect is provided and at the same time in case of a possible removal of this layer 60 the remaining system does not appear optically more conspicuous.

In a preferred embodiment of the anti-reflective coating 100, the upper nitridic hard material layer 50 has the largest layer thickness of the anti-reflective coating 100 and of the entire layer system 200, with a layer thickness in a range from 200 nm to 1000 nm, preferably from 300 nm to 600 nm, most preferably from 400 nm to 500 nm.

The upper nitridic hard material layer 50 preferably accounts for a fraction of the total layer thickness of the layer system 200 of at least 0.4, preferably at least 0.6, more preferably at least 0.7.

By virtue of the specific configuration or structure of the anti-reflective coating 100 that includes a significantly thicker hard material layer 50 than is typically used in a color-neutral antireflection system, increased scratch resistance is achieved.

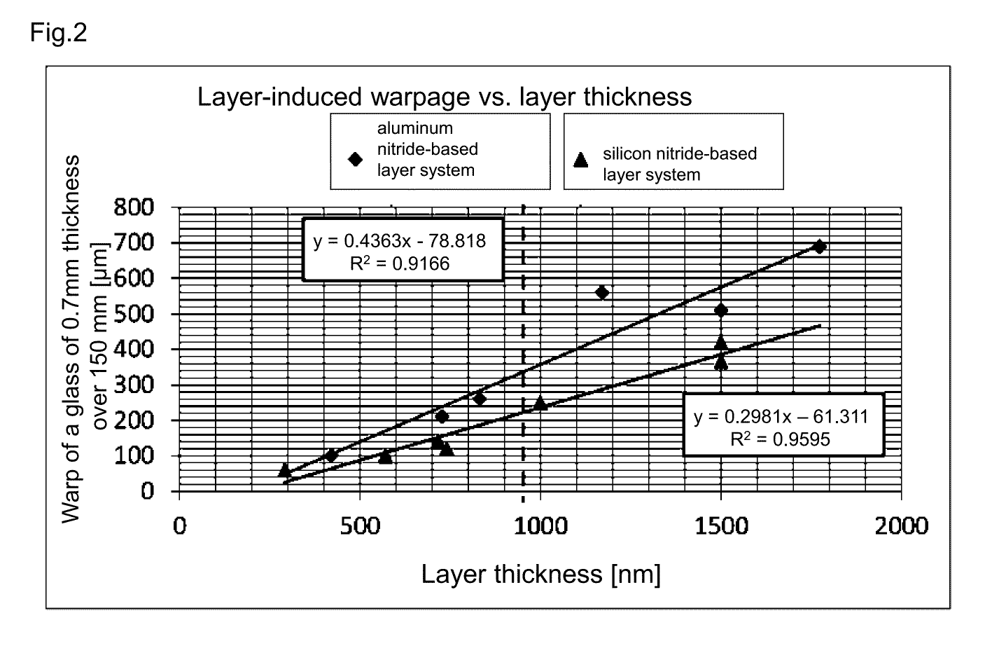

FIG. 2 shows the layer-induced deformation or warpage, in micrometers, in chemically tempered glass substrates with aluminum nitride-based coating systems, in particular for hard anti-reflective systems, and of silicon nitride-based coating systems, in particular for scratch-resistant anti-reflective coatings, as a function of layer thickness in nanometers.

As can be seen from FIG. 2, with increasing layer thickness coating systems based on silicon nitride exhibit significantly lower layer-induced warpage than systems based on aluminum nitride. Consequently, silicon nitride-based layer systems are presently preferred over aluminum nitride-based systems, in particular for glasses for which a lowest possible warpage is important.

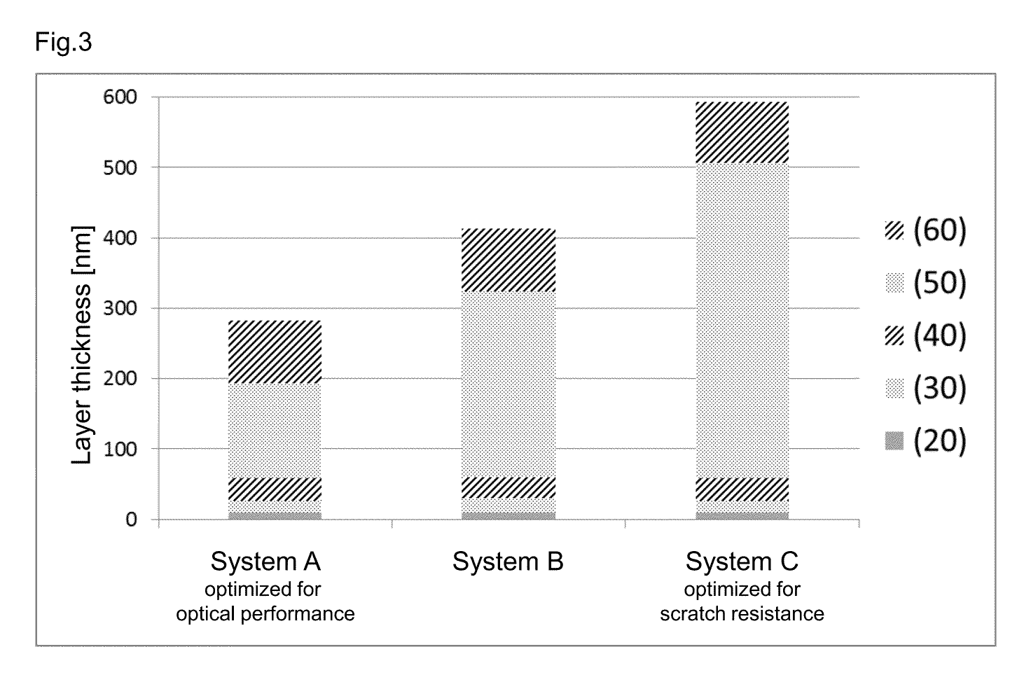

FIG. 3 shows a comparison of three exemplary chemically tempered glass substrates having coatings of different thicknesses, System A, System B, and System C. System A is a chemically tempered glass substrate having a coating system 200 which comprises an adhesion promoting layer 20 and a four-layered anti-reflective coating 100 including layers 30, 40, 50, and 60, wherein the upper nitridic hard material layer 50 has a thickness which is less than one third of that of the particularly hard System C which otherwise has a substantially identical structure. In system B, the hard material layer 50 has a thickness which is less than two-thirds of that of system C which otherwise has a substantially identical structure.

In the specific examples of System A, System B, and System C shown in FIG. 3, the thickness of the lowermost layer, namely adhesion promoting layer 20, is 10 nm in each case, the thickness of the subsequent silicon nitride-containing higher-index layer 30 is between 10 and 20 nm in each case, the thickness of the further layer 40 is between 30 and 40 nm in each case, the thickness of the upper silicon nitride-containing higher-index layer 50 is from 130 nm to 140 nm for System A, from 260 nm to 270 nm for System B, and from 420 nm to 450 nm for System C, while the thickness of the uppermost layer 60 of the anti-reflective coating 100 is about 90 nm in all three systems A, B, and C.

Without being limited to the illustrated example, the following ranges of layer thicknesses are preferred:

Preferably, the anti-reflective coating 100 has a thickness in a range from 200 nm to 700 nm.

According to a particularly preferred embodiment on which the embodiments of FIG. 3 are based, an anti-reflective coating 100 is provided which comprises a layer stack of four successive layers, 30, 40, 50, 60, of which the lowermost layer 30 is a silicon nitride-containing higher-index layer, and in which the further silicon nitride-containing higher-index layer 50 which forms the uppermost higher-index layer of the layer stack has the largest layer thickness in the layer stack, and in which the uppermost layer 60 of the layer stack is a layer having a lower refractive index and including silicon oxide, preferably with a proportion of aluminum, which has the second largest layer thickness among the layers of the layer stack. According to yet another embodiment which is also implemented in the coatings illustrated in FIG. 3, the lower nitridic hard material layer 30 and the layer 40 of lower refractive index disposed thereon together have a smaller layer thickness than the uppermost layer 60 of the anti-reflective coating 100, with the uppermost layer 60 preferably having the second largest layer thickness of the anti-reflective coating 100. With such a sequence of layers, high scratch resistance is achieved and at the same time a good antireflection effect.

In particular, in the example of System C shown on the right in FIG. 3, the layer thickness of the uppermost high-index layer is very large. The illustrated example is optimized for a very high scratch resistance. Without being limited to the specific example illustrated it is suggested for obtaining high scratch resistance that the layer thickness of the upper high-index nitridic layer 50 of the anti-reflective coating is greater than the sum of the layer thicknesses of the other layers 30, 40, 60 of the anti-reflective coating 100.

Thus, System C with a particularly large thickness of the upper nitridic hard material layer 50 is optimized for scratch resistance.

By contrast, System B comprises a layer system which represents a compromise between very good scratch resistance and excellent optical performance. Very surprisingly, experiments showed that a System B was found between the two Systems A and C, which meets the optical and mechanical requirements with substantially merely a change of the layer thickness of the upper high refractive index layer 50. The most surprising was that this System B is an excellent compromise between the high scratch resistance of System C and the very good optical performance of System A. The anti-reflective effect of System B is even slightly better than that of System A, but with a smaller width of the anti-reflective effect in terms of wavelength range.

In contrast to System C and System B, System A comprises a layer system focused on optical performance.

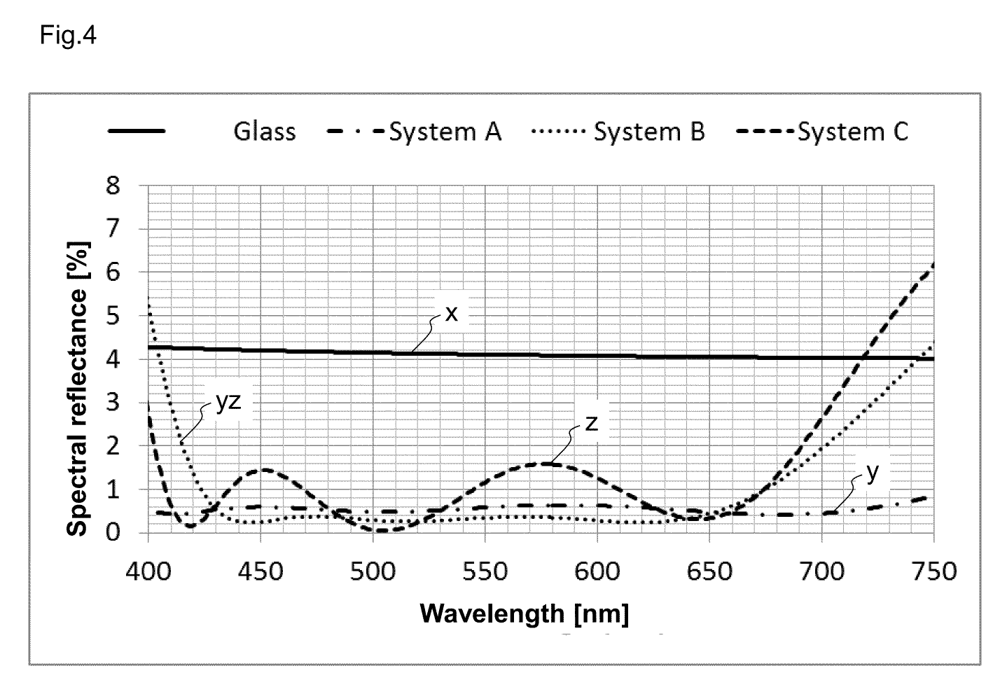

This is also apparent from the determined characteristics of spectral reflectance shown in FIG. 4. Solid curve X represents the spectral reflectivity or reflectance of a non-coated chemically tempered glass, which is typically 4%. Dot-dashed curve Y represents the spectral reflectivity or reflectance of a chemically tempered glass coated with the layer system or anti-reflective coating according to System A (of FIG. 3). Curve Z shown as a dashed line represents the spectral reflectivity or reflectance of a chemically tempered glass substrate with the layer system or anti-reflective coating, i.e. a glass element according to System C (of FIG. 3). Surprisingly, the anti-reflection properties of System C are only slightly inferior to those of System A which is optimized for low reflectivity. Dotted curve yz represents the spectral reflectance of a chemically tempered glass which is coated with the layer system or anti-reflective coating according to System B (of FIG. 3). Surprisingly, the anti-reflection properties of System B are better in terms of depth of the anti-reflective effect than that of System A which is optimized for low reflectivity.

As proven by FIG. 4, it is possible with a layer system according to the invention to achieve an antireflection effect with a reduction in reflectance of more than 3% with a neutral color appearance. Average reflectance in the visible spectral range of preferably 400 nm to 700 nm is substantially less than 2% or even substantially less than 1%.

The effect of the mechanical resistance or the efficacy in terms of scratch susceptibility of the chemically tempered glass elements coated according to the invention and therefore being scratch-resistant, is examined with a sandpaper or abrasive paper test in which the effect of sand grains and/or corundum particles on the glass elements is simulated.

Measurements of the increase in haze value as caused by the sandpaper test were performed on the same coated substrates on which FIGS. 3 and 4 were based, and furthermore on a substrate provided with System C and with an additional organofluorine layer 70 (see FIG. 1).

The haze measurement is performed according to the standard ASTM D1003-95, wherein for the light transmitted through the glass element the proportion of scattered light is compared to the intensity of the total light transmitted.

The scattered radiation is a measure of the fraction of the surface damaged by scratches. A defect in the surface of the glass leads to a deflection of the beam incident perpendicular to the glass surface. The more damages exist on the surface, the more radiation is kept away from the detector. Thus, the haze value, given in percent, is a measure of the degree of damage of the surface. The haze value of an undamaged coated glass or a non-coated glass is about 0.1.

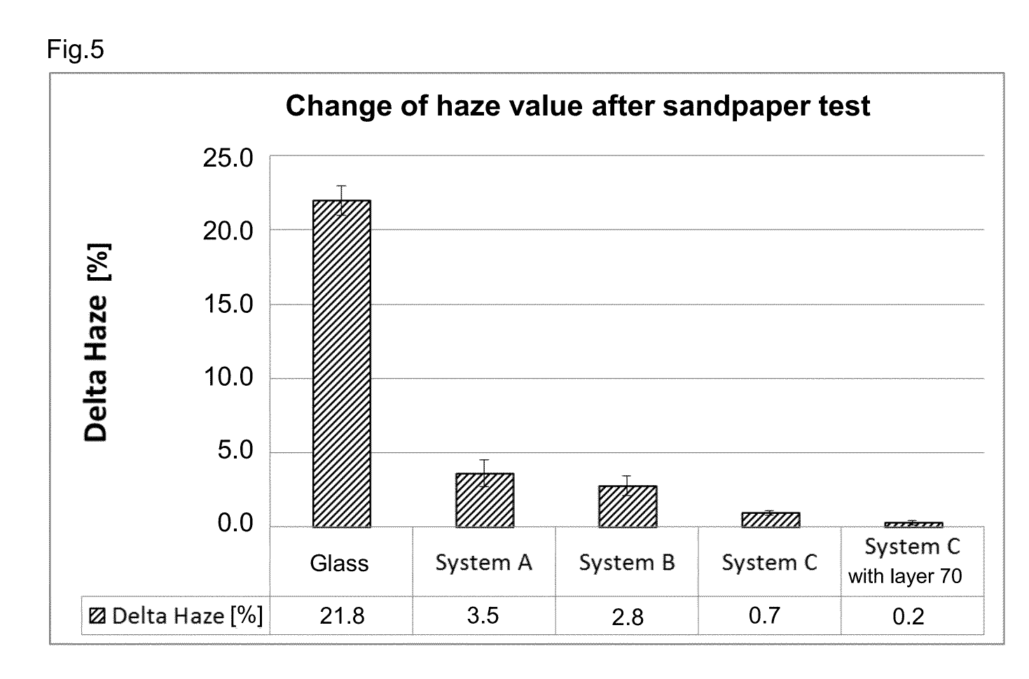

The results of the haze measurements are shown in FIG. 5 as bar charts. The measured values in FIG. 5 thus reflect the percentage increase of the scattered light component due to scratches and other damage to the substrate surface after the sandpaper test.

The change in haze value after the sandpaper test in FIG. 5 shows that the coating of glass substrate 10, 11 with the layer system 200 according to System C (of FIG. 3) which is optimized for scratch resistance with a particularly large layer thickness of the upper nitridic hard material layer 50 of the anti-reflective coating 100, achieves a surprisingly clear improvement over the non-coated glass substrate and also over the layer system 200 of System A (of FIG. 3) in which the upper nitridic layer 50 of the anti-reflective coating 100 has a thickness of less than one third of that of System C. The layer system 200 of System C shows a reduction in the change of the haze value after a sandpaper test to about 1/30 of that of the non-coated chemically tempered glass substrate. The haze value of System B in which the nitridic hard material layer 50 is about twice as thick as that of System A is about 75% of that of system A.

Surprisingly, it has further been found that a layer system 200 in which an additional organofluorine layer 70 is added in addition to the anti-reflective coating 100 according to System C, as shown in FIG. 1, is not only effective to prevent fingerprints from being produced or to provide for easy cleanability, but that the so coated chemically tempered glass substrate in particular helps to avoid scratches. As can be seen from FIG. 5, the measured haze value of System C is further reduced by more than a factor of three. The layer system 200 according to System C with the organofluorine layer 70 shows a reduction in the change of the haze value after a sandpaper test by about two orders of magnitude as compared to the non-coated chemically tempered glass substrate.

This is attributed to the fact that the additional organofluorine layer 70 presumably reduces the friction coefficient of the surface so that indenting and canting of the abrasive materials of the sandpaper is considerably reduced and damage to the surface is therefore lower.

As a preferred deposition method for producing the layer structure of the anti-reflective coating or layer system for the chemically tempered glass substrate, sputtering is employed, in particular magnetron sputtering, and most preferably medium-frequency magnetron sputtering which is particularly advantageous in form of reactive sputtering because in this case both the silicon oxide of the low-index layers and preferably also the silicon nitride for the high-index layers can be produced with the same target. The switchover to the different layer materials may simply be effected by changing the process parameters, in particular the composition of the process gas.

It has been found that the layers produced by this method not only are very dense, but also have an extremely smooth surface. Just this seems to particularly enhance the mechanical resistance to scratching and abrasion, since the layer surface hardly offers points of attack and damage cannot spread emanating from irregularities of the coating.

This method permits to produce layers or layer surfaces which have a root mean square (RMS) roughness value of less than 1.5 nanometers, even less than 1 nanometer, based on an area of 1 square micrometer. The same values apply to average roughness Ra. Average roughness even tends to be slightly lower than root mean square roughness.

Furthermore favorably, the layer properties may be influenced very beneficially by a specific sputtering method which is referred to as HiPIMS method (High Power Impulse Magnetron Sputtering) or HPPMS method (High Power Pulse Magnetron Sputtering). This deposition method is a pulsed sputtering method in which high-energy pulses are generated which result in high power densities on the target well above the 10 W/cm² typical for sputtering.

The glass elements of the invention as described above, in form of coated chemically tempered glass substrates such as those exemplified in FIG. 1 and/or in FIG. 3, are particularly suitable as a cover glass for optical displays of electronic devices, in particular with or without touch functionality, in particular mobile phones, smart phones, tablet PCs, and PCs with touch display, monitors, television sets, navigation devices, public displays and terminals, and/or industrial displays.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

### LIST OF REFERENCE NUMERALS

1 Scratch-resistant chemically tempered glass element
10 Chemically tempered glass substrate
11 Potassium-rich surface of the chemically tempered glass substrate
20 Oxygen-rich layer, adhesion promoting layer
30 (Lower) nitridic hard material layer having a higher refractive index
40 (Lower) layer having a lower refractive index, preferably comprising silicon oxide with a proportion of aluminum
50 (Upper) nitridic hard material layer having a higher refractive index
60 (Upper) layer having a lower refractive index, preferably comprising silicon oxide with a proportion of aluminum
70 Organofluorine layer
100 Anti-reflective coating
200 Layer system
X Solid curve X represents the spectral reflectivity or reflectance of a non-coated chemically tempered glass
Y Dot-dashed curve Y represents the reflectivity or reflectance of a chemically tempered glass coated with the layer system or anti-reflective coating according to System A (of FIG. 3)
Z Dashed curve Z represents the reflectivity or reflectance of a chemically tempered glass substrate with the layer system or anti-reflective coating according to System C (of FIG. 3)
YZ Dotted curve YZ represents the spectral reflectivity or reflectance of a chemically tempered glass coated with the layer system or anti-reflective coating according to System B (of FIG. 3)

1. A scratch-resistant chemically tempered glass element, comprising:
a chemically tempered glass substrate having a potassium-rich surface; and
a layer system comprising a plurality of successive layers, including an oxygen-rich layer adjacent the potassium-rich surface of the glass substrate,
wherein said oxygen-rich layer comprises predominantly silicon oxide and/or aluminum oxide,
wherein said oxygen-rich layer is an adhesion promoting layer for a nitridic hard material layer which is the lowermost part of a multi-layered anti-reflective coating composed of layers of different refractive indices, alternating higher refractive indices and lower refractive indices.

2. The scratch-resistant chemically tempered glass element of claim 1, wherein the layers having a higher refractive index comprise a nitride and the layers having a lower refractive index comprise silicon oxide with a proportion of aluminum.

3. The scratch-resistant chemically tempered glass element of claim 1, wherein the oxygen-rich layer has a layer thickness from 1 nm to 100 nm, and has a similar refractive index as the chemically tempered glass substrate.

4. The scratch-resistant chemically tempered glass element of claim 1, wherein an upper nitridic hard material layer has the largest layer thickness of the anti-reflective coating and of the entire layer system,
with a thinner layer thickness in a range from 100 nm to 200 nm, in which case the layer exhibits neutral color reflectivity, or
alternatively, with a thicker layer thickness in a range from 200 nm to 1000 nm, in which case the layer is particularly scratch-resistant.

5. The scratch-resistant chemically tempered glass element of claim 1, wherein the upper nitridic hard material layer has the largest layer thickness of the anti-reflective coating and of the entire layer system,
with a thinner layer thickness in a range from 100 nm to 200 nm or a medium layer thickness of the upper nitridic hard material layer from 200 nm to 300 nm, in which case the anti-reflective coating is scratch-resistant, or
alternatively, with a thicker layer thickness of the upper nitridic hard material layer in a range from 300 nm to 1000 nm, in which case the anti-reflective coating is particularly scratch-resistant.

6. The scratch-resistant chemically tempered glass element of claim 1, wherein the upper nitridic hard material layer accounts for a fraction of at least 0.4 of the total layer thickness of the layer system.

7. The scratch-resistant chemically tempered glass element of claim 1, wherein the layer system comprises an organofluorine layer adjacent to the uppermost layer of the anti-reflective coating.

8. The scratch-resistant chemically tempered glass element of claim 1, wherein the hard material layers having a higher refractive index comprise silicon nitride including a proportion of aluminum, with a ratio of the molar amounts of aluminum to silicon of greater than 0.05.

9. The scratch-resistant chemically tempered glass element of claim 1, wherein the glass substrate has been chemically tempered by exchanging sodium ions for potassium ions in the surface thereof, wherein the compressive stress in the surface of the glass substrate is at least 700 MPa and the exchange depth of the alkali ions is at least 25 μm.

10. The scratch-resistant chemically tempered glass element of claim 1, wherein the composition of the chemically tempered glass in the inner glass substrate comprises the following components, in mole percent:
SiO₂ 56-70
Al₂O₃ 10.5-16
B₂O₃ 0-3
P₂O₅ 0-3
Na₂O 10-15
K₂O 0-2
MgO 0-5
ZnO 0-3
TiO₂ 0-2.1
SnO₂ 0-1
F 0-5, and
0-2, preferably 0-1 of other components.

11. The scratch-resistant chemically tempered glass element of claim 1, wherein the glass substrate has a thickness from 0.25 mm to 2.0 mm.

12. An electronic device, comprising:
an optical display; and
the scratch-resistant chemically tempered glass element of claim 1.

13. A method for producing the scratch-resistant chemically tempered glass element of claim 1, wherein the layers of the layer system are deposited by sputtering, in particular reactive sputtering.

14. The scratch-resistant chemically tempered glass element of claim 1, wherein the multi-layered, anti-reflective coating has four layers.

15. The scratch-resistant chemically tempered glass element of claim 3, wherein the oxygen-rich layer has a layer thickness from 1 nm to 20 nm, and has a similar refractive index as the chemically tempered glass substrate, with a deviation of less than 10%.

16. The scratch-resistant chemically tempered glass element of claim 4, wherein the upper nitridic hard material layer has the largest layer thickness of the anti-reflective coating and of the entire layer system,
with a thinner layer thickness in a range from 130 nm to 170 nm, in which case the layer exhibits neutral color reflectivity, or
alternatively, with a thicker layer thickness in a range from 400 nm to 500 nm, in which case the layer is particularly scratch-resistant.

17. The scratch-resistant chemically tempered glass element of claim of claim 5, wherein the upper nitridic hard material layer has the largest layer thickness of the anti-reflective coating and of the entire layer system,
with a thinner layer thickness in a range from 130 nm to 170 nm, or with a medium layer thickness of the upper nitridic hard material layer from 230 nm to 290 nm, in which case the anti-reflective coating is scratch-resistant, or
alternatively, with a thicker layer thickness of the upper nitridic hard material layer in a range from 400 nm to 500 nm, in which case the anti-reflective coating is particularly scratch-resistant.

18. The scratch-resistant chemically tempered glass element of claim 6, wherein the upper nitridic hard material layer accounts for a fraction of at least 0. 7 of the total layer thickness of the layer system.

19. The scratch-resistant chemically tempered glass element of claim 7, wherein the organofluorine layer has a layer thickness of from 1 nm to 10 nm.

20. The scratch-resistant chemically tempered glass element of claim 8, wherein the hard material layers having a higher refractive index comprise silicon nitride including a proportion of aluminum, with a ratio of the molar amounts of aluminum to silicon of greater than 0.08

21. The scratch-resistant chemically tempered glass element of claim 9, wherein the compressive stress in the surface of the glass substrate is more than 800 MPa and the exchange depth of the alkali ions is at least 35 um.
